(19) United States
(12) Patent Application Publication
(10) Pub. No.: US 2026/0187832 A1
(43) Pub. Date: Jul. 2, 2026

(54) SYSTEM AND METHOD FOR TRAINING AN EYE STATE PREDICTOR

(71) Applicant: PUPIL LABS GmbH, Berlin (DE)

(72) Inventors: Kai DIERKES, Berlin (DE); Bernhard PETERSCH, Berlin (DE); Michael DREWS, Berlin (DE)

(73) Assignee: PUPIL LABS GmbH, Berlin (DE)

(21) Appl. No.: 19/130,226

(22) PCT Filed: Dec. 21, 2022
(86) PCT No.: PCT/EP2022/087323

§ 371 Date: May 15, 2025

(51) Int. Cl. G06T 7/73; G06T 7/12; G06V 10/26; G06V 10/774; G06V 10/82; G06V 40/18

(52) U.S. Cl. CPC G06T 7/73; G06T 7/12; G06V 10/26; G06V 10/774; G06V 10/82; G06V 40/193; G06T 2207/20081; G06T 2207/20084; G06T 2207/30201

(57) ABSTRACT

A system and method for training a neural network eye state predictor is disclosed. In one example, the method includes feeding a first eye-related observation as input to the eye state predictor to determine a predicted 3D eye state of at least one eye of the subject for a time. The predicted 3D eye state is fed as input to a differentiable predictor to determine a prediction for the at least one eye of the subject for the time. Based on the prediction and at least one of the first eye-related observation and a second eye-related observation, a training loss is determined. The second eye-related observation refers to the at least one eye of the subject for the time. The training loss is used to train the eye state predictor.

### TECHNICAL FIELD

Embodiments of the present invention relate to systems and methods for training an eye state predictor implemented as a neural network, in particular as a convolutional neural network, and a method for predicting a 3D eye state for a subject in real time, in particular for a subject wearing a head-wearable device.

### BACKGROUND

Over the last decades a wide variety of camera-based eye trackers have been proposed. In general, methods for determining gaze direction can be categorized into such which rely on the explicit extraction of features from eye images, and such which do not rely on such explicit feature extraction, but instead accept the entire image of an eye (or of both eyes) as an input to some kind of pre-trained algorithm, like a machine learning algorithm, for example a trained neural network. The latter methods are often called appearance-based, in contrast to the former explicit feature-based methods. Feature-based methods can be further separated into regression-based and model-based approaches. Regression-based approaches typically employ polynomial mapping functions, which after a person-specific calibration are used to predict gaze direction (typically 2D gaze coordinates on a screen) based on suitable eye image features (typically 2D pupil centers). Model-based approaches fit a mathematical 3D eye model to extracted eye image features (typically a series of pupil contours) and next to 3D gaze direction allow for the estimation of other pertinent parameters characterizing three-dimensional (3D) eye state, as e.g. eyeball center position and pupil radius. In all these methods, explicit extraction of eye features such as pupil center, IR glint position (reflections actively generated by IR LEDs), or pupil contours is usually performed by classic computer vision and image processing algorithms or by machine learning based methods.

Many known head mounted eye trackers suffer from the disadvantage that environmental stray light being reflected on the test user's eye may negatively influence the eye tracking functionality. In feature-based eye tracking approaches, cameras monitoring the test user's eyes may not be able to distinguish between features of the eyes explicitly used for keeping track of the eye movement and features, such as spurious reflections, arising from environmental lighting conditions. Reliable eye tracking is therefore often compromised by environmental conditions and undesired stray light disturbing the tracking mechanism. Thus, known head mounted eye tracker devices often suffer from a limited robustness when dealing with large variations of environments and appearance of users.

Head-mounted eye trackers which employ appearance-based (learning-based) gaze estimation methods have been shown to deal much better with such large variations of environmental light conditions and appearance of users, giving very good accuracy even in an uncalibrated setting. Such methods however require large amounts of labelled training data which include images of the eyes and corresponding gaze coordinates, e.g. within images of a front facing scene camera, and are also challenging to calibrate. Due to the lack of corresponding ground truth data, they are usually also not able to (reliably) yield interesting 3D eye state parameters. This is because neural networks in the context of eye tracking are usually only trained direct supervision by means of using gaze point or gaze direction ground truth data, which is available from dedicated data collection sessions, to perform end-to-end gaze prediction on input 2D eye images, or with 2D image features which are directly visible or annotatable on 2D eye images, to perform eye feature extraction.

While well-calibrated feature-based methods can still yield an even higher accuracy than appearance-based learning methods, in many use cases such as head-mounted eye trackers a highly controlled and calibrated setup is hard or even impossible to achieve. Accordingly, both gaze estimation paradigms have advantages and disadvantages.

Further, model-based approaches for gaze estimation using head-mounted eye trackers that are based on fitting of a mathematical 3D eye model to a series of pupil contours extracted from 2D eye images usually assume that the center of rotation of the eyeball is fixed in the eye camera coordinate system, which may only be approximately true due to so-called head-set slippage, i.e. unavoidable movements of the headset with respect to the head of the user during usage, and, thus, may require real-time eye model updates as explained in WO 2020/244752 A1.

Accordingly, there is a need to further improve the detection of gaze direction and other eye state parameters.

### SUMMARY

According to an embodiment of a method for training an eye state predictor, which is implemented as a neural network, in particular as a convolutional neural network, the method includes feeding a first eye-related observation as input to the eye state predictor to determine, for an observation situation, a predicted 3D eye state of at least one eye of the subject as output of the eye state predictor, the first eye-related observation referring to the at least one eye of the subject in and/or during the observation situation. The predicted 3D eye state is fed as input to a differentiable predictor to determine, for the observation situation, a prediction for the at least one eye of the subject as output of the differentiable predictor. Based on the prediction and at least one of the first eye-related observation and a second eye-related observation, a training loss is determined. The second eye-related observation also refers to the at least one eye of the subject in and/or during the observation situation. The training loss is used to train the eye state predictor.

Accordingly, the eye state predictor, which is in the following also referred to as eye state predictor model, is (based on the training loss(es) that may also be referred to as prediction loss(es)) trained to output a corresponding 3D eye state upon receiving eye-related observation(s).

At least the first eye-related observation typically includes an image referring to the at least one eye of the subject, in particular a respective eye image recorded by an eye camera and showing at least a portion of the left eye of the subject (left eye image) or the right eye of the subject (right eye image). More typically, the first eye-related observation typically includes a pair of corresponding left eye image and right eye image or a concatenated eye image, i.e. an eye image formed by concatenating left eye image and right eye image. The left eye image and the right eye image may in particular be provided by respective eye cameras of a head-wearable device worn by the subject.

The observation period of the observation situation may correspond to typical video frame rates and/or be comparatively short, for example less than 0.2 s, more typically less than 0.02 s. In these embodiments, the left eye image and the right eye image may correspond to an image of a respective video stream provided by the eye cameras.

While an eye-related observation typically at most includes and/or is determined based on at most one left eye image and at most one corresponding right eye image, it is also possible that an eye-related observation include and/or is determined based on a typically short sequence of left eye images and/or the right eye images, for example a respective sequence with a length of at most 5 or 10.

Further, the observation situation may refer to and/or be represented by at least one of the (corresponding) observation time (observation date), and an observation identity (ID) typically depending on the observation time.

According to embodiments, a method for training the eye state predictor includes feeding a first eye-related observation as input to the eye state predictor to determine a predicted 3D eye state of at least one eye of the subject for an observation time as output of the eye state predictor, the first eye-related observation referring to the at least one eye of the subject for the observation time. The predicted 3D eye state is fed as input to a differentiable predictor to determine a prediction for the at least one eye of the subject for the observation time as output of the differentiable predictor. Based on the prediction and at least one of the first eye-related observation and a second eye-related observation referring to the at least one eye of the subject for the observation time, in particular based on the prediction and one of the first eye-related observation and the second eye-related observation, a training loss is determined. The training loss is used to train the eye state predictor.

In the following, the methods for training an eye state predictor are also referred to as training methods.

The methods for training eye state predictors as explained herein allow to combine the advantages of feature-based, model-based and appearance-based learning methods to achieve both accurate and robust 3D eye state prediction.

In particular, the eye state prediction model may be trained to receive a 2D (camera) image of an eye of the subject (or a pair of corresponding images of a left eye and a right eye of the subject), as in above mentioned appearance-based methods, but instead of merely yielding a gaze point or direction, to output, for a given use case, a typically complete 3D eye state including or consisting of a (data) set or vector of eye state values, for example 3D eyeball center coordinates, 3D gaze direction and 3D pupil size.

The term “3D eye state” as used herein intends to describe a set of quantities or values, in particular a respective vector describing, typically characterizing a (an actual) three-dimensional state of at least one eye of the subject at a given time, i.e. a left eye, in the following also referred to as first eye, a right eye, in the following also referred to as second eye, both eyes, and/or a cyclopean eye of the subject.

A set (only) consisting of two-dimensional (2D) values that are directly visible in eye images, like for example a 2D pixel location of an eye bounding box within a remotely taken image of the face of a subject or a 2D pupil image (ellipse) property is not to be understood as a “3D eye state”.

The 3D eye state typically refers to and/or includes one or more, typically two or three 3D observables (physical quantities that can be measured) of the at least one eye of the subject.

The (predicted) 3D eye state can include any (measured/measurement based) value that characterizes the physiologically constant or transient parameters describing a respective eye in 3D, in particular the 3D center of rotation of the eyeball, the 3D gaze direction, e.g. a vector characterizing the optical or visual axis/line-of-sight, and/or the size of the pupil aperture (“pupil size”) in 3D.

The (predicted) 3D eye state typically includes at least one of, typically at least two of, for example three of or even all of: a predicted 3D center (of rotation) of an eyeball of the at least one eye, a 3D gaze direction of the at least one eye, a 3D state of an eyelid of the at least one eye and a 3D state of a pupil of the at least one eye.

Typically, the (predicted) 3D state of the pupil includes at least one of a predicted 3D pupil size of the at least one eye, a predicted 3D pupil aperture of an iris of the at least one eye, a predicted 3D pupil radius of an iris of the at least one eye, and a predicted 3D pupil diameter of the iris of the at least one eye.

The (predicted) 3D state of the eyelid of the at least one eye may include at least one of an eyelid shape, an eyelid position, and a percentage of an eyelid closure.

Further, the predicted 3D eye state may be a monocular state, a pair of corresponding left and right monocular states or a binocular state.

In embodiments referring to 3D eye states consisting of a predicted 3D center of the eyeball of the at least one eye, a 3D gaze direction of the at least one eye, and a 3D state of a pupil of the at least one eye, the predicted 3D eye state is typically one of: a 6-dimensional vector (characterizing a monocular 3D eye state), a 10-dimensional vector (characterizing a binocular 3D eye state) and a 12-dimensional vector (characterizing a binocular 3D eye state). Note that the two monocular 3D eye states of a subject are related to each other for physiological reasons. Therefore, a 10-dimensional or 11-dimensional data set (vector) is typically sufficient to characterize the 3D eye state. In other words, a binocular 3D eye state may, depending on the applicable constraint(s), be represented by a lower dimensional data set (e.g. vector) compared to a combined data set (e.g. vector) representing two corresponding left and right (monocular) 3D eye states.

During training, training parameters of the eye state predictor, i.e. model parameters to be trained/parameters the eye state predictor model learns by optimizing the loss function, in particular the weights of the connections between the artificial neurons of the neural network (NN), are changed, typically iteratively.

The eye state predictor may be trained by machine learning (ML) and using machine learning algorithms, respectively. In particular, a respective ML optimization algorithm such as backpropagation may be used to train the eye state predictor. Accordingly, a (at least one) loss function referring to, typically mathematically characterizing and/or providing a measure for a difference or a discrepancy between the prediction(s) of the eye state predictor (model) and the eye-related observation(s) is used to determine the training loss and to train the eye state predictor, respectively. Note, for backpropagation to be employable, all steps in the computational graph, i.e. all calculations leading from the input of the algorithm to the final loss function, have to be differentiable.

The eye state predictor may be trained using a directly supervised training scheme or an indirectly supervised training scheme.

The eye-related observations usable for training the eye state predictor may include further data referring to the at least one eye of the subject.

In particular, the eye-related observations for training may be determined using a head-wearable device worn by the subject and providing the eye camera, typically a left eye camera, a right eye camera, and optionally a scene camera and/or additional sensors such as an inertial measurement unit as components. Data provided by these components (also as postprocessed data/derived data) during the observation situation and/or for the observation time may also be part of the respective eye-related observation.

Accordingly, further data (e.g. sensor readouts of the head-wearable device) may be used for training the eye state predictor. Accordingly, accuracy and/or robustness of the 3D eye state prediction of the trained eye state predictor may be further improved.

The first eye-related observation and the second eye-related observation, respectively, used for training the eye state predictor may include a respective eye image of the eye(s) of the subject recorded by the respective eye camera (of the head-wearable device) during the observation situation and/or for the observation time as a primary eye-related observation, and/or a corresponding secondary eye-related observation(s) which is derived from the eye image(s).

The secondary eye-related observation typically includes a visual feature determined for and/or extracted from the respective eye image, more typically several respective visual features such as edges, boundaries between and/or positions of anatomical features identified in the eye images, and/or is implemented as visual feature representation of the eye image including the visual feature(s). The visual feature(s) of the respective eye image may be determined using feature detection algorithms such as feature point detection, edge detection, and/or semantic segmentation.

The secondary eye-related observation may in particular be a semantic segmentation of the respective eye image which is in the following also referred to as semantically segmented eye image.

Semantic segmentation (also known as image segmentation) may be described as clustering and/or partitioning a digital image into image segments, and providing, for the digital image, a semantically segmented image consisting of the segments that may completely cover the digital image. During semantic segmentation, objects and/or (segment) boundaries may be detected in the digital image. Further, image segmentation typically includes assigning labels to the pixels in the digital image such that pixels with the same label share one or more characteristics. For example, pixel identified as belonging to a pupil in a digital eye image may be assigned with a pupil label.

In particular, the first eye-related observation and/or the second eye-related observation may include a left eye image of a left eye and a right eye image of a right eye of the subject recorded by the respective eye camera during the observation situation and/or for the observation time as a respective primary eye-related observation.

Further, the first eye-related observation and/or the second eye-related observation may include a secondary eye-related observations derived from the left image and a secondary eye-related observations derived from the right eye image, in particular a semantic segmentation of the left eye image (semantically segmented left eye image) and a semantic segmentation of the right eye image (semantically segmented right eye image).

The semantic segmentation of the respective eye image may include at least one label which is typically selected from a list consisting of a pupil label, an iris label, a sclera label, an eyelid label, a skin label, and an eye lash label. Using such a label for training the eye state predictor may also improve the training results.

The training method may include determining, typically using a scene camera of the head-wearable device, a scene observation referring to a field of view of (the at least one eye of) the subject during the observation situation and/or for the observation time as an eye-related observation, for example as the second eye-related observation during the observation situation and/or for the observation time.

The scene observation may include a scene image (recorded by the scene camera) as a primary eye-related observation, and/or a (at least one) secondary eye-related observation derived from the scene image, in particular a semantic segmentation of the scene image, a 3D gaze point typically measured in scene camera coordinates, and a 2D gaze point typically measured in the scene camera image coordinates.

Furthermore, the first eye-related observation and/or the second eye-related observation may include at least one of: a corneo-retinal standing potential of the at least one eye of the subject during the observation situation and/or for the observation time, a velocity of a head of the subject during the observation situation and/or for the observation time, an acceleration of the head of the subject during the observation situation and/or for the observation time, an orientation of the head of the subject during the observation situation and/or for the observation time, respective 2D gaze point during the observation situation and/or for the observation time and a 3D gaze point during the observation situation and/or for the observation time as a respective primary observation.

The method for training the eye state predictor is typically performed iteratively.

Accordingly, a plurality of respective eye-related observations may be (determined using an eye camera and) used for the training (once or several times).

Further, the respective eye-related observations for different subjects may be (determined using an eye camera and) used for the training.

The observation situation may be represented by a subject ID and the observation time, or an observation (identity) ID depending on the subject ID and the observation time. Further, the observation ID may depend on an ID of the hardware used for taking the images (hardware ID), in particular a device ID of the head-wearable device.

The determined eye-related observation may be buffered and/or stored in a (training) database (for the eye-related observations), in particular prior to the actual training of the eye state predictor.

During the actual training (cycles) of the eye state predictor, the database may be used for determining the first eye-related observation and the second eye-related observation, respectively, typically several (first) eye-related observations to be fed as input to the eye state predictor.

For example, an eye-related observation may typically randomly be retrieved from the database and fed to the eye state predictor outputting a corresponding prediction. The training loss may be determined based on the corresponding prediction, and one or even both of: the retrieved eye-related observation and a further eye-related observation retrieved from the database and corresponding to the same observation situation (including the observation time).

In embodiments in which the differentiable predictor is an identity operator (identity function), the predicted 3D eye state and a corresponding 3D eye state (for the observation situation and/or the observation time) may be used to determine the training loss. Alternatively, an operator, which is in the following also referred to as scaling operator, mapping the input to a typically linearly scaled version of the input as output may be used to determine the training loss.

The corresponding 3D eye state may be determined using the first eye-related observation but differently compared to the 3D eye state. Alternatively, the corresponding 3D eye state may be determined using the second eye-related observation, or using both the first eye-related observation and the second eye-related observation (or respective parts thereof). Even further, the corresponding 3D eye state may be determined using a sequence of eye-related observations. In particular, a 3D geometric eye model may be used to determine the corresponding 3D eye state such that the corresponding 3D eye state fits to the first eye-related observation (and/or the second eye related observation or the sequence of eye-related observations in the above alternatives).

Typically, a 3D geometric eye model taking into account corneal refraction is used to determine the corresponding 3D eye state.

In other embodiments the differentiable predictor is different to the identity operator and has non-vanishing (non-constant) derivatives with respect to the parameters of the eye state predictor.

In particular, the differentiable predictor may be configured to output, in response to receiving the predicted 3D eye state as input from the eye state predictor, a synthetic eye image or a pair of left and right synthetic eye images.

In this embodiment, the training loss is typically determined based on the synthetic eye image(s) and a corresponding semantic segmentation of the eye image(s). Note that the synthetic eye image(s) may be considered as secondary eye-related observations, and/or may be stored in the database.

Likewise, a left eye image of a left eye and a right eye image of a right eye of the subject fed as input to the eye state predictor may be considered as first eye-related observations which may also be stored in the database.

The (non-identity) differentiable predictor may in particular be based on or even be implemented as a trained neural network, in particular a generative neural network and/or as a differentiable renderer such as an approximate ray tracer, i.e. a differentiable ray tracer.

In one embodiment, the differentiable predictor is implemented as a neural network which is trained using a 3D eye model such as a LeGrand 3D eye model or a Navarro 3D eye model (see e.g. WO 2020/244752 A1 and references [1], [2] cited therein), and any non-differentiable ray tracer that is configured to generate artificial images given the 3D eye model, a 3D eye state and the camera properties, i.e. image resolution and camera intrinsics of the used eye camera(s).

In another embodiment, the differentiable predictor is implemented as a ray-tracing algorithm which is designed to generate eye images which are consistent with a 3D eye model such as a LeGrand 3D eye model or a Navarro 3D eye model (see e.g. WO 2020/244752 A1 and references [1], [2] cited therein), or any non-differentiable ray tracer that is configured to generate artificial images given the 3D eye model, in an appropriate way to achieve differentiability of the generated images with respect to the internal parameters of the model.

In these embodiments, the training loss may be a region-based loss, in particular a Jaccard loss.

As used herein, the term “camera intrinsics” shall describe that the optical properties of the camera, in particular the imaging properties (imaging characteristics) of the camera are known and/or can be modelled using a respective camera model including the known intrinsic parameters (known intrinsics) approximating the eye camera producing the eye images. Typically, a pinhole camera model is used for modelling the eye camera. The known intrinsic parameters may include a focal length of the camera, an image sensor format of the camera, a principal point of the camera, a shift of a central image pixel of the camera, a shear parameter of the camera, and/or one or more distortion parameters of the camera.

In embodiments in which only one differentiable predictor (e.g. a first differentiable predictor) is used, only one loss function (e.g. a first loss function) may be used to determine the (total) training loss.

In particular, the prediction output by the (first) differentiable predictor and either the first eye-related observation or the second eye-related observation may be fed to the (first) loss function outputting the (first) training loss.

In other embodiments, at least two differentiable predictors, e.g. two, three or even more differentiable predictors may be used to determine a respective prediction for the at least one eye of the subject during the observation situation and/or for the observation time, wherein the (total) training loss is determined based on each of the respective predictions. Accordingly, training efficiency, prediction accuracy and/or prediction may be further improved.

In particular, the predicted 3D eye state may be fed as input to a first differentiable predictor to determine a first prediction for the at least one eye of the subject during the observation situation and/or for the observation time as output of the first differentiable predictor (DP).

Likewise, the predicted 3D eye state may be fed as input to a second differentiable predictor to determine the second prediction for the respective eye of the subject during the observation situation and/or for the observation time as output of the second differentiable predictor.

Further, the first prediction and either the first eye-related observation or the second eye-related observation may be fed as input to a first loss function to determine a first training loss as output of the first loss function.

Likewise, the second prediction and one of the first eye-related observation, the second eye-related observation and a third eye-related observation referring to the observation situation may be fed as input to a second loss function to determine a second training loss as output of the second loss function.

The first and second training losses may be used to train the eye state predictor and to change parameters of the eye state predictor, respectively.

In particular, the eye state predictor may be trained using a (total) training loss determined as a function of the first training loss and the second training loss, for example as typically weighted sum.

The (total) training loss may depend on at least one situation-specific parameter.

In particular, both the eye state predictor and the differentiable predictor (or even two or more differentiable predictors) may receive the at least one situation-specific parameter as part of their respective input.

The eye state predictor and the differentiable predictor may receive a common situation-specific parameter, a common set of situation-specific parameters (referring and/or characterizing the observation situation or sequence of observation situation at different observation times under otherwise unchanged conditions, in particular same subject and same hardware) or respective situation-specific parameter(s) from the common set of situation-specific parameters.

The at least one situation-specific parameter typically includes a (at least one) subject-specific parameter.

The (at least one) subject-specific parameter may in particular be selected from a list consisting of: an interpupillary distance (IPD), an angle or both angles between an optical and a visual axis of the respective eye, a rotation operator capturing a transformation between the optical axis and the visual axis, for example a rotation matrix, a geometric parameter referring to a shape and/or a size of a cornea of the respective eye such as spherical, non-spherical, a thickness, an astigmatism, a 3D topography, and a radius, e.g. a spherical radius or an angle dependent radius of the cornea, a refractive index of at least one component of the respective eye, an iris radius of the respective eye, a pupil shape, and a geometric parameter referring to a shape and/or size of an eyeball of the respective eye.

During the training of the eye state predictor, one or more of the situation-specific parameters, in particular respective subject-specific parameter(s) may be determined and/or adapted.

For example, the eye state predictor may receive a respective physiological value for the respective subject-specific parameter(s), for example for a cornea radius of the respective eye, an iris radius of the respective eye, an IPD or an angle(s) between an optical and a visual axis of the respective eyes as an initial input. During the training with eye-related observations of a specific subject, the respective subject-specific parameter(s) may be changed (as part of the optimizing).

In particular, the training loss may be used to amend (or update) the situation-specific parameter(s).

After training, the adapted (learned) situation-specific parameter(s) may be output, stored (e.g. for later use as input for predicting 3D eye states of the subject), further processed and/or used as measured value(s) for the subject (which may otherwise only be measured with high effort).

In embodiments in which the eye state predictor is trained with eye-related observations of different subjects, a respective subject-ID of the eye-related observations facilitates the learning of the subject-specific parameter(s).

In some embodiments only a subset of the situation-specific parameters is learned and/or adapted during the training.

The learned subject-specific parameter(s) may later be used as inputs for predicting a 3D eye state of a subject in real time.

Furthermore, a trained eye state predictor may even be used to determine at least one subject-specific parameter for the new subject.

Further, the at least one situation-specific parameter may include a (at least one) hardware-specific parameter (which may also be learned and/or adapted during the training).

The (at least one) hardware-specific parameter may in particular be selected from a list consisting of: a respective camera intrinsics, relative camera extrinsics and a pose of the inertial measurement unit relative to at least one of the (eye and optional scene) cameras.

Typically, the pose of the camera(s) is/are fixed with respect to each other and/or a coordinate system of the head-wearable device when worn by the subject.

However, cameras with restricted movability (e.g. only along a given axis, like in a VR headset to adjust for individual interpupillary distance) may also be used. In devices with some camera position adjustment capabilities, like VR headset, it may even be possible to implement an alternative position “sensor” which determines, e.g. measures the mutual distances/poses of the cameras.

Camera extrinsics such as known pose information and intrinsics such as focal length, center pixel shift, shear and distortion parameters may be measured during the production of head-wearable device and then linked to a (hardware) ID of the head-wearable device and thus serve as training input (additional “learning aids”). Accordingly, both training of the eye state predictor and accuracy of the predicted 3D eye state output by the trained eye state predictor may be further improved.

According to embodiments, the predicted 3D eye state is used to determine a third training loss that may be used to train the eye state predictor.

In particular, the predicted 3D eye state and the at least one situation-specific parameter may be fed to a third loss function to determine the third training loss.

The third training loss may be determined based on the predicted 3D eye state and the subject-specific parameter(s).

Further, the (total) training loss (training loss to be used for training the predicted 3D eye state) may be determined as a function of the first training loss and the third training loss, or as a function of the first training loss, the second training loss and the third training loss.

According to an embodiment of a method for predicting a 3D eye state for a subject in real time, i.e. with a maximum delay of at most about 0.25 s or 0.1 s, the method, which is in the following also referred to as predicting method, includes determining an eye-related observation referring to at least one eye of the subject, and feeding the eye-related observation as input to a trained eye state predictor (model) implemented as a neural network to determine, typically in real time and/or on the fly, a predicted 3D eye state as output of the trained eye state predictor.

The predicted 3D eye state may in particular include a predicted 3D center of rotation of an eyeball of the at least one eye, and a 3D gaze direction of the eyeball of the at least one eye.

Typically, the predicted 3D eye state further includes a predicted 3D state of a pupil of the at least one eye.

The predicted 3D state of the pupil may include at least one of: a predicted 3D pupil size of the at least one eye, a predicted 3D pupil aperture of an iris of the at least one eye, a predicted 3D pupil radius of an iris of the at least one eye, and a predicted 3D pupil diameter of the iris of the at least one eye.

Typically, the trained eye state predictor is trained according to the training methods as explained herein.

In embodiments in which the training loss depends on one or more subject-specific parameter(s), the subject specific parameter(s) may be determined in advance for new subjects, in particular as a respective physiological value, as respective measured value, using a method for subject-specific calibration (as explained herein) to determine a respective predicted value or any function of one or more of these values.

According to an embodiment of a method for subject-specific parameter calibration, the method includes providing a trained eye state predictor as explained herein, feeding a (respective new) first eye-related observation a respective current value of at least one subject-specific parameter for the new subject as input to the eye state predictor to determine a predicted 3D eye state of at least one eye of a new subject for an (a new) observation situation as output of the trained eye state predictor, the first eye-related observation referring to the at least one eye of the new subject in and/or during the observation situation, feeding the predicted 3D eye state and a current value of at least one subject-specific parameter for the new subject as input to a differentiable predictor to determine a prediction for the at least one eye of the new subject in and/or during the observation situation as output of the differentiable predictor, determining, based on the prediction and at least one of the first eye-related observation and a second eye-related observation, a training loss, the second eye-related observation referring to the at least one eye of the new subject in and/or during the observation situation; and using the training loss to update the respective current value of the at least one subject-specific parameter.

Typically after a plurality of updating cycles, the respective current value of the at least one subject-specific parameter is output as a respective predicted value of the at least one subject-specific parameter (of the respective subject).

Furthermore, for the methods explained herein, an eye camera of a head-wearable device worn by the subject is typically used for taking the at least one eye image (at a given time).

More typically, two respective eye cameras of the head-wearable device are used for taking corresponding (left and right) eye images of the subject (at given time(s)).

The head-wearable device is typically implemented as a spectacles device.

However, the head-wearable device may also be implemented as an augmented reality (AR-) and/or virtual reality (VR-) device (AR/VR headset), in particular a goggles, an AR head-wearable display, and a VR head-wearable display. For the sake of clarity, head-wearable devices are mainly described with regard to head-wearable spectacles devices in the following.

The 3D eye state(s) is/are typically determined with respect to a coordinate system that is fixed to the eye camera(s) and/or the head-wearable device.

For example, a Cartesian coordinate system defined by the image plane(s) of the eye camera(s) may be used.

Points and directions may also be specified within and/or converted into a device coordinate system, a head coordinate system, a world coordinate system or any other suitable 3D coordinate system.

The (head-wearable) spectacles device typically includes a spectacles body, which is configured such that it can be worn on a head of a subject, for example in a way usual glasses are worn. Hence, the spectacles device when worn by a subject may in particular be supported at least partially by a nose area of the subject's face. This state of usage of the head-wearable (spectacles) device being arranged at the subject's face will be further defined as the “intended use” of the spectacles device, wherein direction and position references, for example horizontal and vertical, parallel and perpendicular, left and right, front and back, up and down, etc., refer to this intended use. As a consequence, lateral positions as left and right, an upper and lower position, and a front/forward and back/backward are to be understood from subject's usual view. Equally, this applies to a horizontal and vertical orientation, wherein the subject's head during the intended use is in a normal, hence upright, non-tilted, non-declined and non-nodded position.

The spectacles body (main body) typically includes a left ocular opening and a right ocular opening, which mainly come with the functionality of allowing the subject to look through these ocular openings. Said ocular openings can be embodied, but not limited to, as sunscreens, optical lenses or non-optical, transparent glasses or as a non-material, optical pathway allowing rays of light passing through.

The spectacles body may, at least partially or completely, form the ocular openings by delimiting these from the surrounding. In this case, the spectacles body functions as a frame for the optical openings. Said frame is not necessarily required to form a complete and closed surrounding of the ocular openings. Furthermore, it is possible that the optical openings themselves have a frame like configuration, for example by providing a supporting structure with the help of transparent glass. In the latter case, the spectacles device has the form similar to frameless glasses, wherein only a nose support/bridge portion and ear-holders are attached to the glass screens, which therefore serve simultaneously as an integrated frame and as optical openings.

In addition, a middle plane of the spectacles body may be identified. In particular, said middle plane describes a structural center plane of the spectacles body, wherein respective structural components or portions, which are comparable or similar to each other, are placed on each side of the middle plane in a similar manner. When the spectacles device is in intended use and worn correctly, the middle plane coincides with a median plane of the subject.

Further, the spectacles body typically includes a nose bridge portion, a left lateral portion and a right lateral portion, wherein the middle plane intersects the nose bridge portion, and the respective ocular opening is located between the nose bridge portion and the respective lateral portion.

For orientation purposes, a plane being perpendicular to the middle plane shall be defined, which in particular is oriented vertically, wherein said perpendicular plane is not necessarily firmly located in a defined forward or backward position of the spectacles device.

The head-wearable device has an eye camera having a sensor arranged in or defining an image plane for taking images of a first eye of the subject, i.e. of a left or a right eye of the subject. In other words, the eye camera, which is in the following also referred to as camera and first eye camera, may be a left eye camera or a right (near-) eye camera. The eye camera is typically of known camera intrinsics.

In addition, the head-wearable device may have a further eye camera of known camera intrinsics for taking images of a second eye of the subject, i.e. of a right eye or a left eye of the subject. In the following the further eye camera is also referred to as further camera and second eye camera.

In other words, the head-wearable device may, in a binocular setup, have a left and a right (eye) camera, wherein the left camera serves for taking a (left) image or a stream of images of at least a portion of the left eye of the subject, and wherein the right camera takes a (right) image or a stream of images of at least a portion of a right eye of the subject.

Typically, the first and second eye cameras have the same or similar camera intrinsics (are of the same type, but may be individually calibrated).

However, the methods explained herein are also applicable in a monocular setup with one (near) eye camera only.

The eye camera(s) can be arranged at the spectacles body in inner eye camera placement zones and/or in outer eye camera placement zones, in particular wherein said zones are determined such, that an appropriate picture of at least a portion of the respective eye can be taken for the purpose of determining one or more eye-state-related parameters; in particular, the cameras are arranged in a nose bridge portion and/or in a lateral edge portion of the spectacles frame such, that an optical field of a respective eye is not obstructed by the respective camera. The optical field is defined as being obstructed, if the camera forms an explicitly visible area/portion within the optical field, for example if the camera points out from the boundaries of the visible field into said field, or by protruding from the boundaries into the field. For example, the cameras can be integrated into a frame of the spectacles body and thereby being non-obstructive. In the context of the present invention, a limitation of the visible field caused by the spectacles device itself, in particular by the spectacles body or frame is not considered as an obstruction of the optical field.

Furthermore, the head-wearable device may have illumination means for illuminating the left and/or right eye of the subject, in particular if the light conditions within an environment of the spectacles device are not optimal.

Further, the head-wearable device may be provided with a scene camera for taking images of the field of view (FOV) of the subject wearing the head-wearable device, for example an integrated scene camera typically arranged in the middle plane.

The predicting method may at least in part be controlled and/or performed by a computing and control unit of the head-wearable device.

Alternatively or in addition, a companion device functionally connected with the computing and control unit (or only a control unit) of the head-wearable device of the system, e.g. via a wired or wireless network (TCPIP) connection and/or an USB connection, in particular a mobile companion device such as a smart phone, a tablet, or a laptop connected with the head-wearable device, or a desktop computer may supervise, control and/or perform the predicting methods as explained herein.

Typically, the computing system (hardware) performing the training methods and/or the predicting methods as explained herein includes one or more processors, in particular one or more CPUs, GPUs and/or DSPs, and a neural network software module including instructions which, when executed by at least one of the one or more processors, implement (an instance of) the neural network.

According to an embodiment of a system, in particular a training system for eye state predictors, the system includes a head-wearable device including at least one eye camera configured to generate eye images of at least a portion of an (at least one) eye of the subject wearing the head-wearable device, and a computing system which is connectable with the at least one eye camera for receiving the eye images, and is configured to generate, based on an eye image referring to an observation situation and received from the at least one eye camera, a first eye-related observation referring to the (at least one) eye of the subject in and/or during the observation situation; to run an eye state predictor implemented as a neural network; to feed the first eye-related observation as input to the eye state predictor to determine a predicted 3D eye state of the (at least one) eye of the subject in and/or during the observation situation; to feed the predicted 3D eye state as input to a differentiable predictor to determine a prediction for the (at least one) eye of the subject in and/or during the observation situation as output of the differentiable predictor; to determine, based on the prediction and at least one of the first eye-related observation and a second eye-related observation also referring to the eye of the subject in and/or during the observation situation, a training loss; and to use the training loss to train the eye state predictor.

Typically, the computing system is configured to determine the second eye-related observation differently compared to the first eye-related observation.

The head-wearable device typically includes a respective eye camera for each eye of the subject.

Further, the first eye-related observation may be generated based on respective (left and right) eye images of the left and right eye of the subject during the observation situation and/or for an observation time at which the eye images are generated.

Likewise, the second eye-related observation may, even if determined differently, also be generated based on respective (left and right) eye images.

Furthermore, the head-wearable device may include a scene camera configured to generate scene images referring to a field of view of the subject wearing the head-wearable device.

Further, the computing system may be configured to host or access a database for the eye-related observations.

Accordingly, the typically iteratively performed training of the eye state predictor (model) may be facilitated.

The computing system may in particular be configured to perform the training methods as explained herein.

The (actual) training cycles of the eye state predictor are typically performed after generating a plurality of eye-related observations, and/or by a sufficiently powerful computing hardware, for example a respective (remote) server and/or cloud-based architecture.

The computing system may also be configured to perform the predicting methods as explained herein.

The predicting methods are, compared to the training methods, less compute intensive. Thus, the predicting methods may even be controlled and/or performed by a controller (typically providing a computing and control unit) of the head-wearable device, which is typically configured to run a trained eye state predictor (instance) implemented as neural network and/or may even be integrated into the head-wearable device, by a connected companion device such as a smartphone or by the (computing and) control unit of the head-wearable device and the companion device.

The term “neural network” (NN) as used in this specification intends to describe an artificial neural network (ANN) or connectionist system including a plurality of connected units or nodes called artificial neurons. The output signal of an artificial neuron is calculated by a (non-linear) activation function of the sum of its input signal(s). The connections between the artificial neurons typically have respective weights (gain factors for the transferred output signal(s)) that are adjusted during one or more learning phases. Other parameters of the NN that may or may not be modified during learning may include parameters of the activation function of the artificial neurons such as a threshold. Often, the artificial neurons are organized in layers which are also called modules. The most basic NN architecture, which is known as a “Multi-Layer Perceptron”, is a sequence of so called fully connected layers. A layer consists of multiple distinct units (neurons) each computing a linear combination of the input followed by a nonlinear activation function. Different layers (of neurons) may perform different kinds of transformations on their respective inputs. Neural networks may be implemented in software, firmware, hardware, or any combination thereof. In the learning phase(s), a machine learning method, in particular a supervised, unsupervised or semi-supervised (deep) learning method may be used. For example, a deep learning technique, in particular a gradient descent technique such as backpropagation may be used for training of (feedforward) NNs having a layered architecture. Modern computer hardware, e.g. GPUs makes backpropagation efficient for many-layered neural networks. A convolutional neural network (CNN) is a feed-forward artificial neural network that includes an input (neural network) layer, an output (neural network) layer, and one or more hidden (neural network) layers arranged between the input layer and the output layer. The speciality of CNNs is the usage of convolutional layers performing the mathematical operation of a convolution of the input with a kernel. The hidden layers of a CNN may include convolutional layers as well as optional pooling layers (for down sampling the output of a previous layer before inputting it to the next layer), fully connected layers and normalization layers. At least one of the hidden layers of a CNN is a convolutional neural network layer, in the following also referred to as convolutional layer. Typical convolution kernel sizes are for example 3×3, 5 ×5 or 7×7. The usage of convolutional layer(s) can help to compute recurring features in the input more efficiently than fully connected layers. Accordingly, memory footprint may be reduced and performance improved. Due to the shared-weights architecture and translation invariance characteristics, CNNs are also known as shift invariant or space invariant artificial neural networks (SIANNs). In the following, the term “model of a neural network” intends to describe a set of data required to define a neural network operable in software and/or hardware. The model typically includes data referring to the architecture of the NN, in particular the network structure including the arrangement of neural network layers, the sequence of information processing in the NN, as well as data representing or consisting of parameters of the NN, in particular the connection weights within fully connected layers and kernel weights within convolutional layers. In a training phase, the network learns to map the input(s) (eye-related observation(s)) to the corresponding sufficiently precise output result(s) (3D eye state(s)).

Other embodiments include corresponding computer systems, (non-volatile) computer-readable storage media or devices, and/or computer programs recorded on one or more computer-readable storage media or computer storage devices, each configured to perform the processes of the methods described herein.

A system of and/or including one or more computers can be configured to perform particular operations or processes by virtue of software, firmware, hardware, or any combination thereof installed on the one or more computers that in operation may cause the system to perform the processes. One or more computer programs can be configured to perform particular operations or processes by virtue of including instructions that, when executed by a one or more processors of the system, cause the system to perform the processes.

Those skilled in the art will recognize additional features and advantages upon reading the following detailed description, and upon viewing the accompanying drawings.

### BRIEF DESCRIPTION OF THE DRAWINGS

The components in the figures are not necessarily to scale, instead emphasis being placed upon illustrating the principles of the invention. Moreover, in the figures, like reference numerals designate corresponding parts. In the drawings:

FIG. 1A and FIG. 1B illustrate respective flow charts of a method for training an eye state predictor according to embodiments;

FIG. 1C illustrates a flow chart of a method for predicting a 3D eye state for a subject in real time according to embodiments;

FIG. 1D illustrates 3D eye states of a subject according to embodiments;

FIGS. 2A, 2B illustrate respective flow charts of a method for training an eye state predictor according to embodiments;

FIG. 2C illustrates a flow chart of a method for training an eye state predictor according to embodiments;

FIGS. 3A, 3B illustrate respective flows charts of a method for training an eye state predictor according to embodiments;

FIGS. 4A, 4B, 4C illustrate respective flows charts of a method for training an eye state predictor according to embodiments;

FIG. 5A illustrates a flow chart of a method subject-specific parameter calibration according to embodiments;

FIG. 5B illustrates a flow chart of a method for training an eye state predictor according to embodiments; and

FIG. 5C illustrates perspective view of a system including a head-wearable device according to embodiments.

### DETAILED DESCRIPTION

In the following Detailed Description, reference is made to the accompanying drawings, which form a part hereof, and in which is shown by way of illustration specific embodiments in which the invention may be practiced. In this regard, directional terminology, such as “top,” “bottom,” “front,” “back,” “leading,” “trailing,” etc., is used with reference to the orientation of the Figure(s) being described. Because components of embodiments can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims.

Reference will now be made in detail to various embodiments, one or more examples of which are illustrated in the figures. Each example is provided by way of explanation, and is not meant as a limitation of the invention. For example, features illustrated or described as part of one embodiment can be used on or in conjunction with other embodiments to yield yet a further embodiment. It is intended that the present invention includes such modifications and variations. The examples are described using specific language which should not be construed as limiting the scope of the appended claims. The drawings are not scaled and are for illustrative purposes only. For clarity, the same elements or manufacturing steps have been designated by the same references in the different drawings if not stated otherwise.

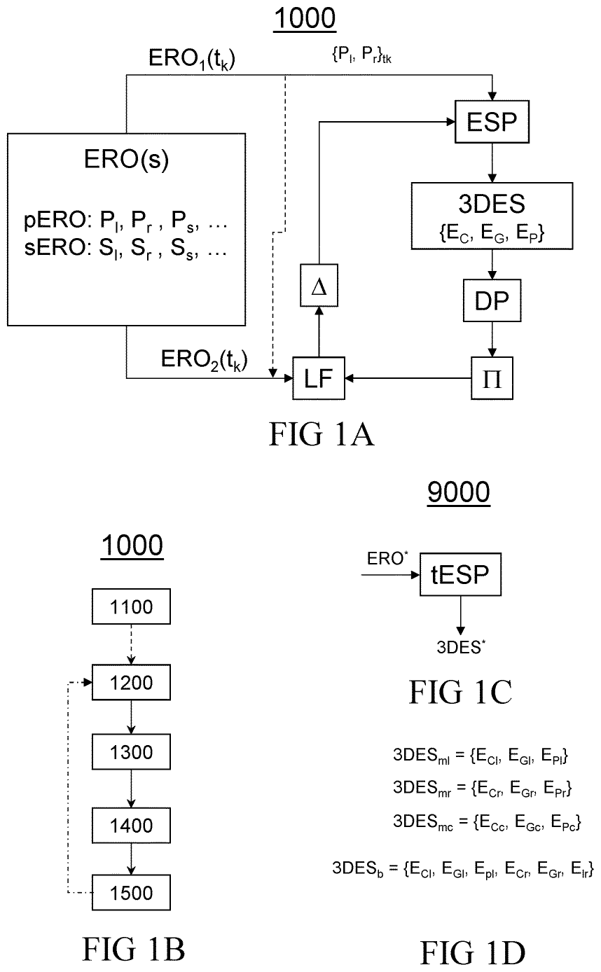

With reference to FIGS. 1A and 1B a method 1000 for training an eye state predictor ESP implemented as a neural network is explained.

In a block 1200 of method 1000 a first eye-related observation ERO₁ is fed as input to the eye state predictor ESP to be trained which outputs a predicted 3D eye state 3DES corresponding to the first eye-related observation ERO₁ for a given observation situation represented by the observation time tₖ, where k is an integer index. The time tₖ and the index k, respectively, may e.g. be selected randomly if training method 1000 is performed repeatedly and/or iteratively (as indicated by the dashed-dotted arrow in FIG. 1B) and the eye-related observation EROs are retrieved from a database filled with the eye-related observations EROs in advance, in a block 1100.

Alternatively or in addition, the first eye-related observation ERO₁ (tₖ) (and optionally a second eye-related observation ERO₂ (tₖ)) may be determined using at least one eye camera or any other eye-related data providing component of a head-wearable device worn by the subject during performing training method 1000 such as a scene camera of the head-wearable device.

At least one of the eye-related observations EROs for the respective observation situation typically include a left eye image Pₗ of a left eye and a right eye image Pᵣ of a right eye of the subject typically recorded by a respective eye camera during the observation situation and/or for the observation time tₖ as a respective primary eye-related observation pERO, and/or a corresponding secondary eye-related observations sERO derived from the left and right eye images Pₗ, Pᵣ, such as a semantic segmentation Sₗ of the left eye image Pₗ and a semantic segmentation Sᵣ of the right eye image Pᵣ.

Further, the eye-related observations EROs for the observation situation may include a scene image Ps typically recorded by a scene camera as a primary eye-related observation pERO and/or at least one corresponding secondary eye-related observation derived from the scene image Ps, in particular derived 2D gaze points or even derived 2D gaze points. Further, a semantic segmentation S_{S} of the scene image P_{S} may be included as secondary eye-related observation.

In the exemplary embodiment, the predicted 3D eye state 3DES is, as indicated by the brackets “{}”, a set (e.g. a vector) consisting of a predicted 3D center E_{C} of an eyeball of at least one eye of a human subject, a predicted 3D gaze direction E_{G} of the at least one eye, and a predicted 3D state E_{P} of a pupil of the at least one eye.

In other embodiments, the predicted 3D eye state 3DES may in addition (or instead of e.g. the predicted 3D state E_{P} of the pupil) include a predicted 3D state of an eyelid of the at least one eye.

As illustrated in FIG. 1D, the predicted 3D eye state 3DES may be one of: a monocular state 3DESₘₗ of a left eye of the subject (with a predicted 3D center Eci of an eyeball of the left eye of the subject, a predicted 3D gaze direction E_{Gl} of the left eye of the subject, and a predicted 3D pupil state E_{Pl} of the left eye of the subject), a monocular state 3DESₘᵣ of a right eye of the subject (with a predicted 3D center E_{Cr} of the eyeball of the right eye of the subject, a predicted 3D gaze direction E_{Gr} of the right eye of the subject, and a predicted 3D pupil state E_{Pr} of the right eye of the subject), a monocular state 3DES_{mc} of a (virtual) cyclopean eye of the subject (with a predicted 3D center E_{Cc} of an eyeball of a cyclopean eye of the subject, a predicted 3D gaze direction E_{Gc} of the cyclopean eye of the subject, and a predicted 3D pupil state E_{Pc} of the cyclopean eye of the subject), and a binocular state 3DES_{b} (with corresponding monocular 3D-states of the left and right eyes of the subject).

While (the right, left and cyclopean) monocular states 3DESₘₗ, 3DESₘᵣ, 3DES_{mc} may be represented by a six-dimensional vector, the binocular state 3DES_{b} may be represented by a ten-dimensional vector or twelve-dimensional vector.

As further illustrated in FIG. 1A and FIG. 1B, the predicted 3D eye state 3DES ({E_{C}, E_{G}, E_{P}}) may be fed as input to a differentiable predictor DP outputting a prediction II referring to the at least one eye of the subject and corresponding to the observation situation, in a subsequent block 1300 of FIG. 1B. Differentiable predictor DP may have one or more non-vanishing derivatives with respect to its input observables as variables.

In a subsequent block 1400, the prediction II and the first eye-related observation ERO₁ (tₖ) (dashed arrow in FIG. 1A) and/or a second eye-related observation ERO₂ (tₖ) referring to the at least one eye of the subject in and/or during the same observation situation tₖ, typically one of ERO₁ (tₖ) and ERO2(tₖ) are fed to loss function LF outputting a corresponding training loss Δ which is used to train the eye state predictor ESP, in a block 1500.

For example, the first eye-related observation ERO₁ may be a primary eye-related observation and the loss function LF may receive the prediction Π and a secondary eye-related observation which is derived from the primary eye-related observation, or a different primary eye-related observation as the second eye-related observation ERO₂ (tₖ).

Alternatively, N eye-related observations may be fed to the eye state predictor ESP outputting M predictions that are compared to L other eye-related observations to calculate the loss Δ (with positive integer numbers N, M, L each of which may be larger than 1). Typically, 1<N<100, M<=N, and/or L<N.

In one example, 20>N>1, M=1, and L=M (or e.g. L<=N). Accordingly, one prediction Π may be determined for a short sequence of N eye-related observation, for example as a mean prediction Π, and compared with a representative (other) eye-related observation referring to the same time interval (L=M=1), or with a mean eye-related observation determined using L>1, for example L=N (other) eye-related observations.

After a plurality of training cycles, the resulting trained eye state predictor (model) tESP may be used for predicting 3D eye states for the same or a different subject in real time.

As illustrated in FIG. 1C for an exemplary predicting method 9000, a (newly) just determined eye-related observation ERO* may be input to the trained eye state predictor tESP outputting a corresponding predicted 3D eye state 3DES*.

Method 9000 may in particular be performed for a subject wearing a head-wearable device of the same type as used for training method 1000.

Further, method 9000 may be performed several times and/or substantially continuously while the subject is wearing the head-wearable device and e.g. looking at a real 3D-scene, a 3D representation of the real scene or a virtual 3D-scene (presented on a screen).

Furthermore, the predicted 3D eye state(s) 3DES* may be further processed, in particular used to determine intentions of the subject and/or interact with the subject, for example present additional information (acoustically and/or visually) and change the 3D representation of the real scene or the virtual 3D-scene.

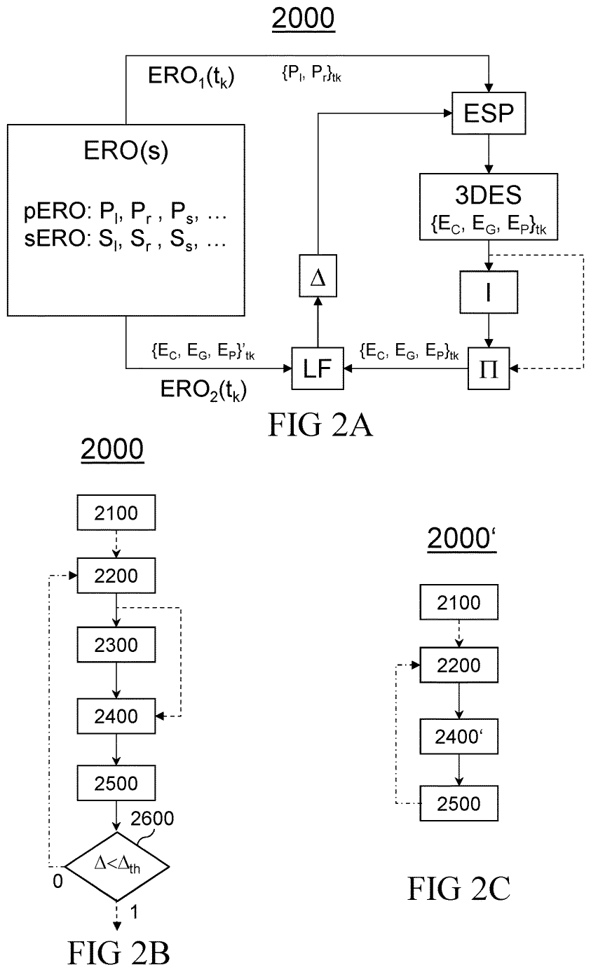

FIG. 2A and FIG. 2B illustrate a training method 2000. Training method 2000 is similar to training method 1000 explained above with respect to FIGS. 1A, 1B and includes blocks 2100 to 2500 each of which is typically similar to a corresponding block of blocks 1100 to 1500 of method 1000. However, training method 2000 is more specific.

In the exemplary embodiment, the differentiable predictor of block 2300 is an identity operator I.

Accordingly, the predicted 3D eye state 3DES ({E_{C}, E_{G}, E_{P}}) determined in block 2200 is forwarded as prediction Π in block 2300, and used as input of the loss function LF in block 2400.

As illustrated by the dashed arrows in FIGS. 2A, 2B, using an identity operator in block 2300 may also be considered as bypassing block 2300 and using the predicted 3D eye state 3DES ({E_{C}, E_{G}, E_{P}}), which is determined in block 2200 as output of the eye state predictor ESP upon receiving a first eye-related observation ERO₁ (tₖ), as prediction Π and input of the loss function LF in block 2400, respectively.

According to an embodiment which is illustrated in FIG. 2C, a method 2000′ for training an eye state predictor ESP includes feeding, in a block 2100, a first eye-related observation ERO₁ as input to the eye state predictor ESP to determine a predicted 3D eye state 3DES, {E_{C}, E_{G}, E_{P}} of at least one eye of a subject for an observation situation, that may refer to and/or be represented by an observation time tₖ, as output of the eye state predictor ESP, wherein the first eye-related observation refers to the at least one eye of the subject in and/or during the observation situation; determining, in a block 2400′, based on the first eye-related observation ERO₁ and a second eye-related observation also referring to the at least one eye of the subject for (in and/or during) the observation situation, a training loss 4; and using the training loss (Δ) to train the eye state predictor ESP, in a block 2500.

In the embodiments of FIG. 2A to FIG. 2C, the respective loss function LF typically receives as second input (second eye-related observation) a corresponding 3D eye state {E_{C}, E_{G}, E_{P}}′ (with the same observables) determined differently compared to the 3D eye state ({E_{C}, E_{G}, E_{P}}) but also referring to the at least one eye of the subject for (in and/or during) the observation situation.

As further shown in FIG. 2B, (direct supervision training) method 2000 may be performed until the training loss Δ (or a floating average of the training loss Δ) is below a predetermined threshold Δₜₕ.

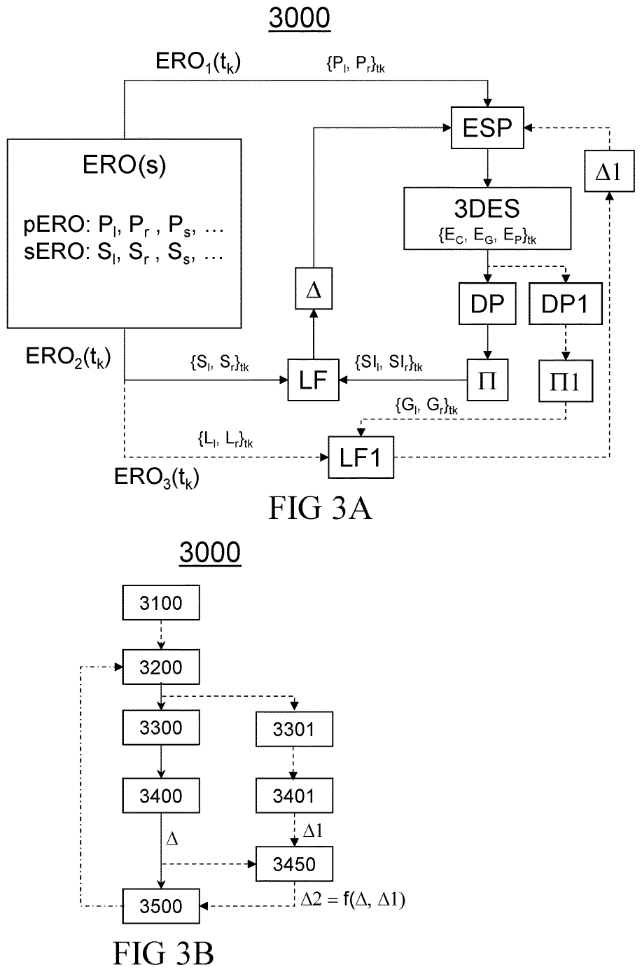

With respect to FIGS. 3A, 3B, a training method 3000 is explained. Method 3000 is also similar to training method 1000 explained above with respect to FIGS. 1A, 1B and includes blocks 3100 to 3500 each of which is typically similar to a corresponding block 1100 to 1500 of method 1000. However, training method 3000 is more specific.

In the exemplary embodiments of FIGS. 3A, 3B, two different differentiable predictors DP, DP1 are used, in respective blocks 3300, 3301, to determine a respective prediction P, P1 referring to the at least one eye of the subject during the observation situation tₖ.

Further, the first prediction Π and a second eye-related observation ERO₂ referring to the same observation situation tₖ may be fed as input to a first loss function LF to determine a first training loss Δ as output of the first loss function LF, in block 3400.

In an alternative the first eye-related observation and the first prediction Π may be fed as input to a first loss function LF.

Likewise, the second prediction Π1 and a third eye-related observation referring to the same observation situation tₖ may be fed as input to a second loss function LF1 to determine a second training loss Δ1 as output of the second loss function LF1, in block 3401.

For example, a differentiable renderer may be used in block 3300 to determine a synthetic left eye image SIₗ and a synthetic right eye image SIᵣ (as first prediction P) which are, in block 3400, compared with semantic segmentation Sₗ, Sᵣ of a left eye image Pₗ and a right eye image Pᵣ, respectively, which are part or even form the first eye-related observation, for determining the first loss Δ.

Further, a 2D gaze prediction Gₗ, Gᵣ for the left eye and the right eye, respectively, may be determined as the second prediction Π1 in block 3401, and compared with respective 2D gaze values or labels Lₗ, Lᵣ which have been determined independently.

The first training loss Δ and the second training loss Δ1 may be used to train the eye state predictor ESP.

Typically, a total training loss Δ2 is determined as a function f(Δ, Δ1) of the first training loss Δ and the second training loss Δ1, in a block 3450, for example as a weighted average, and the training may be performed based on the total training loss Δ2 in block 3500.

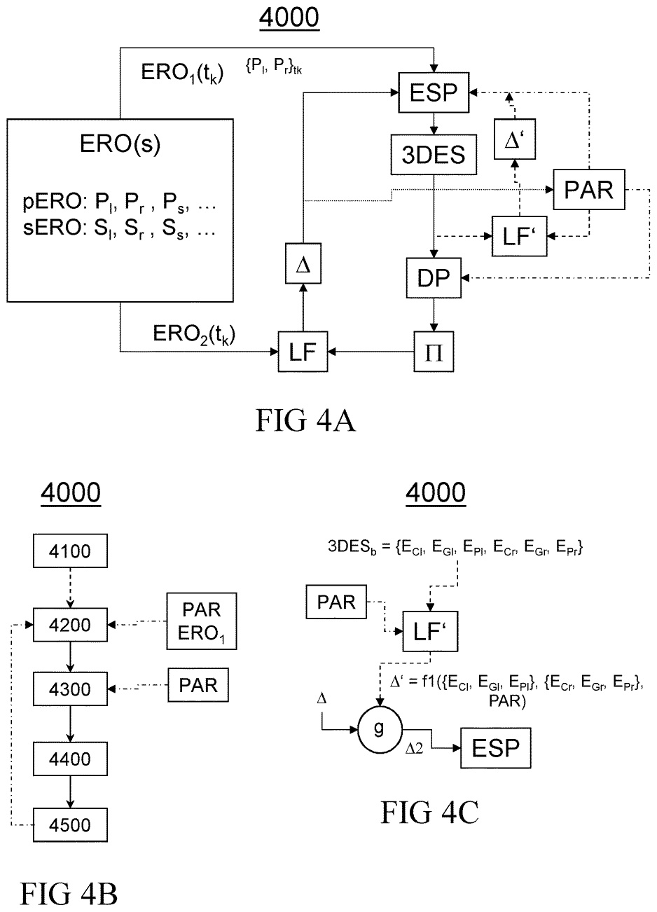

With respect to FIGS. 4A, 4B, 4C a training method 4000 is explained. Method 4000 is also similar to training method 1000 explained above with respect to FIGS. 1A, 1B and includes blocks 4100, 4200, 4300, 4400, 4500 each of which is typically similar to a corresponding block 1100 to 1500 of method 1000. However, training of the eye state predictor3DES and determining the training loss(es) Δ, Δ′ respectively, according to training method 4000 depends on at least one situation-specific parameter PAR.

In particular, one or both of determining the predicted 3D eye state 3DES in block 4200 and determining the prediction Π as output of the differentiable predictor DP in block 4300 may depend on one or more situation-specific parameters PAR. The situation-specific parameter(s) PAR used in blocks 4200, 4300 may (at least in part) be the same, but may also be completely different depending on the training setup.

For example, the differentiable predictor DP may receive as input the predicted 3D eye state 3DES, for example the binocular state 3DES_{b} with a predicted 3D center Eci of the eyeball of the left eye, a predicted 3D gaze direction Eci of the left eye, a predicted 3D pupil state E_{Pl} of the left eye, a predicted 3D center E_{Cr} of the eyeball of the right eye, a predicted 3D gaze direction E_{Gr} of the right eye, and a predicted 3D pupil state E_{Pr} of the right eye of the subject as shown in FIG. 4C, and hardware-specific parameters such as a respective camera intrinsics, relative camera extrinsics and a pose of an inertial measurement unit for the subject's head relative to at least one of the cameras. Accordingly, determining of the prediction P, that may be determined as synthetic eye images, in block 4300 may be facilitated.

Further, a further loss function LF′ (also referred to as third loss function) may be used to determine a further (or third) loss Δ′ depending on the predicted binocular state 3DES_{b} and the subject-specific parameter(s) such as interpupillary distance IPD, and angles between an optical and a visual axis.

For example, loss Δ′ may, optionally depending on the subject-specific parameter(s), be a measure for a symmetry loss, a deviation from an expected distance of or a relationship between the predicted left eye 3D-state and the predicted right eye state of predicted binocular state 3DES_{b}.

For example, loss Δ′ may depend on or even correspond to an IPD loss, i.e. a deviation of an IPD in accordance with the predicted binocular state 3DES_{b} from a physiological (average) IPD or measured IPD of the subject.

Likewise, the loss Δ′ may depend on or even correspond to a loss referring to a deviation from a (an expected) relation between 2D or 3D gaze angles of the left and right eyes, (gaze-angle-symmetry loss), to a loss referring to a difference between the pupils of the left and right eyes such as a pupil size difference, a deviation from a (an expected) 2D or 3D pupil orientation relation of the pupils of the left and right eyes (pupil-symmetry loss), or any (other) symmetry loss of the predicted binocular state 3DES_{b}.

Further, training of the eye state predictor ESP may be based on a total training loss Δ2 determined as a function g of both partial losses Δ, Δ′, as also shown in FIG. 4C.

Furthermore, in particular one or more subject-specific parameters PAR such as cornea radius, iris radius etc. may be changed during the training.

For example and as indicated by the dotted arrow in FIG. 4A, the subject-specific parameter(s) PAR may even be learned by optimizing the loss function LF.

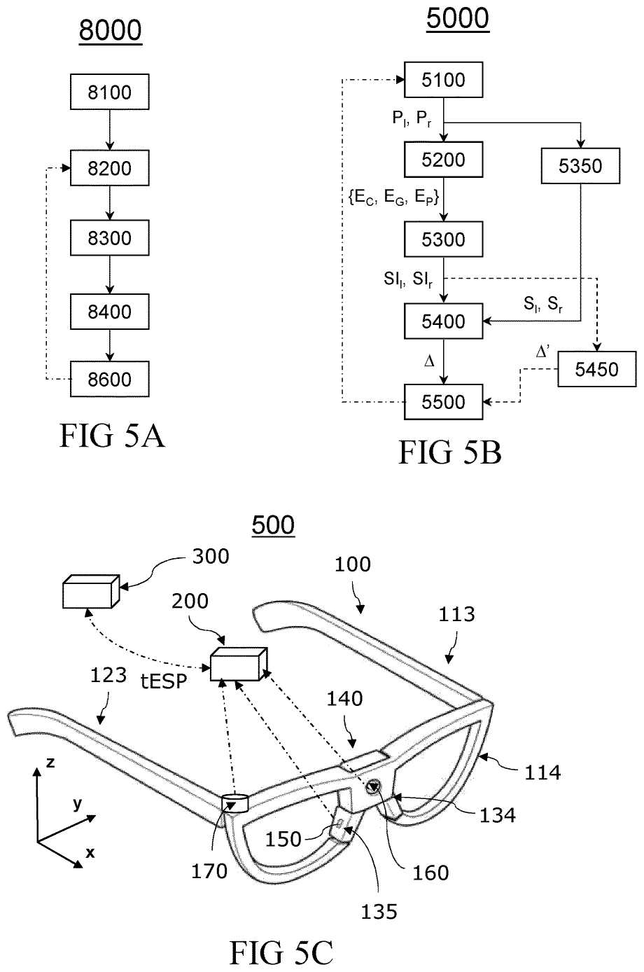

With respect to FIG. 5A a flow chart of a method 8000 for subject-specific parameter calibration is explained.

In a first block 8100, a trained eye state predictor as explained herein is provided. For example, the trained eye state predictor may be obtained as explained above with regard to FIG. 4A-FIG. 4C.

In a subsequent block 8200, a respective first eye-related observation is fed as input to the trained eye state predictor to determine a predicted 3D eye state of at least one eye of a new subject for a new observation situation as output of the eye state predictor. The first eye-related observation refers to the at least one eye of the new subject in and/or during the new observation situation.

In a subsequent block 8300, the predicted 3D eye state and a current value of at least one subject-specific parameter of the new subject is fed as input to a differentiable predictor, for example the differentiable predictor LF1 of FIG. 4A to determine a prediction for the at least one eye of the new subject in and/or during the new observation situation as output of the differentiable predictor.

In a subsequent block 8400, based on the prediction and at least one of the respective first eye-related observation and a respective second eye-related observation referring to the at least one eye of the new subject in and/or during the new observation situation, a training loss is determined.

In a subsequent block 8600, the training loss is used to update the current value of the at least one subject-specific parameter.

Updating the current value of the at least one subject-specific parameter may be done in accordance with an optimizing technique.

Thereafter, method 8000 may return to block 8200.

After a plurality cycles, the current updated value of the at least one subject-specific parameter may be output a respective predicted value for the at least one subject-specific parameter and/or stored in a database.

With respect to FIG. 5B, a training method 5000 is explained. Method 5000 is also similar to training method 1000 explained above with respect to FIGS. 1A, 1B and includes blocks 5100, 5200, 5300, 5400, 5500 each of which is typically similar to a corresponding block 1100 to 1500 of method 1000. However, training method 5000 is more specific.

In a first block 5100, a left eye image Pₗ and a right eye image Pᵣ of a subject are determined for an observation situation, e.g. taken using respective eye cameras or retrieved from a database.

An eye state predictor is used to determine a predicted 3D eye state 3DES, {E_{C}, E_{G}, E_{P}} for the left eye image Pₗ and the right eye image Pᵣ, in a subsequent block 5200, in particular as a predicted binocular 3D eye state.

In a subsequent to block 5300, a synthetic left eye image SIₗ and a synthetic right eye image SIᵣ are determined for the predicted 3D eye state 3DES (as a prediction Π resulting from the predicted 3D eye state 3DES).

Further, a semantic segmentation Sₗ of the left eye image Pₗ and a semantic segmentation Sᵣ of the right eye image Pᵣ are determined in another block 5350 subsequent to block 5100.

Based on a comparison of the synthetic eye images SIₗ, SIᵣ with the semantic segmentation Sₗ, Sᵣ, a training loss Δ is determined in a block 5400.

In a subsequent block 5500, the training loss Δ may be used to train the eye state predictor (model) such as an NN, in particular a CNN using machine learning algorithms, in particular a respective optimization algorithm.

Thereafter, method 5000 may return to block 5100 as indicated by the dashed-dotted arrow.

For example, determining the trainings loss Δ may be based on a first comparison of the synthetic left eye image SIₗ with the semantic segmentation Sₗ of the left eye image Pₗ, and/or on a second comparison of the synthetic right eye image SIᵣ with the semantic segmentation Sᵣ of the right eye image Pᵣ, typically on the first comparison and the second comparison.

Alternatively or more typically in addition to determining the trainings loss Δ in block 5400, a further training loss Δ′ may, in a block 5450, be determined based on a comparison of the synthetic left eye image SIₗ with the synthetic right eye image SIᵣ, and used to train the eye state predictor in block 5500.

FIG. 5C illustrates a system 500 for performing the methods explained herein, in particular the training methods 1000-5000.

In the exemplary embodiment, system 500 includes a head-wearable device 100 implemented as a spectacles device. Accordingly, a frame of spectacles device 100 has a front portion 114 surrounding a left ocular opening and a right ocular opening. A bridge portion of the front portion 114 is arranged between the ocular openings. Further, a left temple 113 and a right temple 123 are attached to front portion 114.

An exemplary camera module 140 is accommodated in the bridge portion and arranged on the wearer-side of the bridge portion. A passage opening for a scene camera 160 of module 140 and the field of view (FOV) of scene camera 160, respectively, is formed in the bridge portion.

The scene camera 160 is typically centrally arranged, i.e. at least close to a central vertical plane between the left and right ocular openings and/or close to (expected) eye midpoint(s) of a human subject wearing the head-wearable device 100 (user). The latter also facilitates a compact design. Furthermore, the influence of parallax error for gaze prediction may be reduced this way significantly.

Furthermore, the scene camera 160 may define a Cartesian coordinate system x, y, z and have an optical axis which is at least substantially arranged in the central vertical plane (to reduce parallax error), arranged in the central x, z-plane and/or pointing in x-direction in the exemplary embodiment.

Leg portions 134, 135 of module 140 may at least substantially complement the frame below the bridge portion so that the ocular openings are at least substantially surrounded by material of frame and module 100.

A right eye camera 150 for taking right eye images of the user, which may be considered as eye-related observational data, and may form at least a part of respective (primary) eye-related observations, is arranged in right leg portion 135.

Likewise, a left eye camera 150 for taking left eye images of the user may be arranged in left leg portion 134 (for providing eye-related observational data).

In the exemplary embodiment, the head-wearable device 500 is additionally provided with an inertial measurement unit 170 for measuring movements and/or orientations of the head-wearable device 500 and a human subject wearing the head-wearable device 500, respectively.

Both, the scene camera 160 and the inertial measurement unit 170 may provide respective (primary)eye-related observational data for the user.

As indicated by the dashed-dotted arrows in FIG. 5C, a computing system 200, 300 of system 500 is connectable with the scene camera 160 for receiving scene images, connectable with the eye camera(s) 150 for receiving eye images, and connectable with the inertial measurement unit 170 for receiving data referring to movements and/or orientations of the head-wearable device 500.

The computing system 200, 300 is configured to perform the methods explained herein.

For this purpose, the computing system 200, 300 typically includes one or more processors and a (respective) non-transitory computer-readable storage medium comprising instructions which, when executed by the one or more processors, causes system 500 to carry out the methods as explained herein.

In the exemplary embodiment, the computing system 200, 300 comprises several interconnectable parts, namely a first computing unit 200 and a second computing unit 300.

While the first computing unit 200 is typically a local unit or system and/or configured to perform the predicting methods as explained herein, the second computing unit 300 may be a remote unit or system, e.g. even cloud-based, and/or is typically configured to perform the actual training steps (cycles) of the training methods as explained herein (after receiving eye-related observational data via the first computing unit 200).

The second computing unit 300 may be configured to determine eye-related observations from the received eye-related observational data, and even host and/or manage a database for the eye-related observation.

The first computing unit 200 may be implemented as a controller and may even be arranged within a housing of module 140, at least in part.

However, the first computing system 200 may also at least in part be provided by a companion device connectable (with the second computing unit 300 and) to the controller of the head-wearable device 100, for example via a USB-connection (e.g. one of the temples may provide a respective plug or socket), in particular a mobile companion device such as a smartphone, tablet or laptop.

Further, the second computing unit 300 may be configured to upload the trained eye state predictor tESP to the second computing unit 200.

According to an embodiment of a method for training an eye state predictor model, which may be implemented as a neural network, in particular as a convolutional neural network, the method includes feeding a first eye-related observation as input to the eye state predictor to determine a predicted 3D eye state of at least one eye of the subject for an observation situation (that may be represented by an observation ID or an observation time) as output of the eye state predictor model, the first eye-related observation referring to the at least one eye of the subject during the observation situation and/or including first eye-related observational data referring to the at least one eye of the subject during the observation situation. The predicted 3D eye state is fed as input to a differentiable predictor to determine a prediction for the at least one eye of the subject during the observation situation as output of the differentiable predictor. Based on the prediction and at least one of: the first eye-related observation and a second eye-related observation referring to said observation situation and/or comprising second eye-related observational data referring to the at least one eye of the subject during said observation situation and being different from the first eye-related observational data, in particular based on the prediction and one of the first eye-related observation and the second eye-related observation, a (current) training loss is determined. The training loss is used to train the eye state predictor model and/or to change training parameters of the eye state predictor. In particular, the eye state predictor model may be trained by machine learning and using machine learning algorithms, respectively, in particular a respective optimization algorithm.

Although various exemplary embodiments of the invention have been disclosed, it will be apparent to those skilled in the art that various changes and modifications can be made which will achieve some of the advantages of the invention without departing from the spirit and scope of the invention. It will be obvious to those reasonably skilled in the art that other components performing the same functions may be suitably substituted. It should be mentioned that features explained with reference to a specific figure may be combined with features of other figures, even in those cases in which this has not explicitly been mentioned. Such modifications to the inventive concept are intended to be covered by the appended claims.

While processes may be depicted in the figures in a particular order, this should not be understood as requiring, if not stated otherwise, that such operations have to be performed in the particular order shown or in sequential order to achieve the desirable results. In certain circumstances, multitasking and/or parallel processing may be advantageous.

Spatially relative terms such as “under”, “below”, “lower”, “over”, “upper” and the like are used for ease of description to explain the positioning of one element relative to a second element. These terms are intended to encompass different orientations of the device in addition to different orientations than those depicted in the figures. Further, terms such as “first”, “second”, and the like, are also used to describe various elements, regions, sections, etc. and are also not intended to be limiting. Like terms refer to like elements throughout the description.

As used herein, the terms “having”, “containing”, “including”, “comprising” and the like are open ended terms that indicate the presence of stated elements or features, but do not preclude additional elements or features. The articles “a”, “an” and “the” are intended to include the plural as well as the singular, unless the context clearly indicates otherwise.

With the above range of variations and applications in mind, it should be understood that the present invention is not limited by the foregoing description, nor is it limited by the accompanying drawings. Instead, the present invention is limited only by the following claims and their legal equivalents.

### REFERENCE NUMBERS

100 head-wearable device
114 front portion of frame
113, 123 temple
140 camera module
150 (right) eye camera
160 scene camera
170 inertial measurement unit
200, 300 computing system/controller/computing unit/companion device
500 system
1000-1430 method/method steps
3DES, {E_{C}, E_{G}, E_{P}} 3D eye state
DP, DP1 differentiable predictor
ERO, ERO₁, Pₗ, Pᵣ eye-related observation
ESP eye state predictor (model)
pERO primary eye-related observation
sERO secondary eye-related observation
Pₗ, Pᵣ eye images
Sₗ, Sᵣ semantic segmentation of Pₗ, Pᵣ
Δ, Δ1, Δ2, Δ′ training loss
P_{S} scene image
S_{S} semantic segmentation of P_{S}
Π, Π1 prediction
1000 5500 methods, method steps

1-41. (canceled)

42. A method for training an eye state predictor implemented as a neural network, the method comprising:
feeding a first eye-related observation as input to the eye state predictor to determine a predicted 3D eye state of at least one eye of a subject for an observation situation as output of the eye state predictor, the first eye-related observation referring to the at least one eye of the subject in and/or during the observation situation;
feeding the predicted 3D eye state as input to a differentiable predictor to determine a prediction for the at least one eye of the subject in and/or during the observation situation as output of the differentiable predictor;
determining, based on the prediction and at least one of the first eye-related observation and a second eye-related observation, a training loss, the second eye-related observation referring to the at least one eye of the subject in and/or during the observation situation; and
using the training loss to train the eye state predictor.

43. The method of claim 42, wherein the observation situation refers to a corresponding observation time and/or is represented by at least one of the corresponding observation time, an observation ID, and an observation ID depending on the corresponding observation time.

44. The method of claim 42, wherein the first eye-related observation and the second eye-related observation are used to determine the training loss, wherein the second eye-related observation is different from the first eye-related observation, and/or wherein at least one of the first eye-related observation and the second eye-related observation comprises at least one of:
an eye image of an eye of the subject recorded by an eye camera during the observation situation and/or for the observation time as a primary eye-related observation,
a corresponding secondary eye-related observation derived from the eye image, the corresponding secondary eye-related observation comprising at least one visual feature extracted from the eye image and/or being implemented as visual feature representation of the eye image comprising the at least one visual feature,
a left eye image of a left eye and a right eye image of a right eye of the subject recorded by a respective eye camera during the observation situation and/or for the observation time as a respective primary eye-related observation,
a corresponding secondary eye-related observation derived from the left eye image,
a corresponding secondary eye-related observation derived from the right eye image,
a corneo-retinal standing potential of the at least one eye of the subject during the observation situation and/or for the observation time,
a velocity of a head of the subject during the observation situation and/or for the observation time,
an acceleration of the head of the subject during the observation situation and/or for the observation time, an orientation of the head of the subject during the observation situation and/or for the observation time,
respective 2D gaze point during the observation situation and/or for the observation time, and
a 3D gaze point during the observation situation and/or for the observation time as a respective primary observation.

45. The method of claim 44, wherein the corresponding secondary eye-related observation comprises a semantic segmentation of the respective eye image, wherein the semantic segmentation of the respective eye image comprises at least one label selected from a list consisting of a pupil label, an iris label, a sclera label, an eyelid label, a skin label, and an eye lash label.

46. The method of claim 42, further comprising:
determining a scene observation referring to a field of view of the at least one eye of the subject during the observation situation and/or for the observation time as an eye-related observation, wherein the scene observation comprises at least one of: a scene image recorded by the scene camera as a primary eye-related observation, and at least one corresponding secondary eye-related observation derived from the scene image, wherein the at least one corresponding secondary eye-related observation comprises at least one of a semantic segmentation of the scene image, a 3D gaze point measured in scene camera coordinates, and a 2D gaze point measured in scene camera image coordinates.

47. The method of claim 42, further comprising at least one of:
implementing the neural network as a convolutional neural network,
determining the respective eye-related observation using a head-wearable device comprising the eye camera, the head-wearable device comprising at least one of a left eye camera, a right eye camera, a scene camera, and an inertial measurement unit,
determining, using an eye camera, at least the first eye-related observation during the observation situation and/or for the observation time;
storing the first eye-related observation in a database;
using the database to determine the first eye-related observation;
using the database to determine the second eye-related observation;
feeding several eye-related observations as input to the eye state predictor to determine a respective predicted 3D eye state of the at least one eye.

48. The method of claim 42, wherein the predicted 3D eye state comprises at least one of: a predicted 3D center of an eyeball of the at least one eye, a predicted 3D gaze direction of the at least one eye, a predicted 3D state of an eyelid of the at least one eye and a predicted 3D state of a pupil of the at least one eye, wherein the 3D state of the pupil comprises at least one of a predicted 3D pupil size of the at least one eye, a predicted 3D pupil aperture of an iris of the at least one eye, a predicted 3D pupil radius of an iris of the at least one eye, and a predicted 3D pupil diameter of the iris of the at least one eye, wherein the 3D state of the eyelid of the at least one eye comprises at least one of an eyelid shape, an eyelid position, an eyelid opening angle and a percentage of an eyelid closure.

49. The method of claim 42, wherein the predicted 3D eye state is a monocular state, a pair of corresponding left and right monocular 3D eye states or a binocular state, wherein the predicted 3D eye state comprises and/or is one of a 6 dimensional vector, a 10 dimensional vector, an 11 dimensional vector and a 12 dimensional vector, and/or wherein the binocular state is represented by a data set with a lower dimensionality than the sum of the dimensionalities of the corresponding left and right monocular 3D eye states.

50. The method of any of claim 42, wherein the differentiable predictor is an identity operator, and wherein the predicted 3D eye state and a corresponding 3D eye state for during the observation situation and/or the observation time are used to determine the training loss.

51. The method of claim 50, wherein the corresponding 3D eye state is determined using the first eye-related observation, different to the predicted 3D eye state or using the second eye-related observation, wherein the corresponding 3D eye state is determined using at least one of a 3D geometric eye model and a 3D geometric eye model taking into account corneal refraction.

52. The method of claim 42, wherein the differentiable predictor is different to an identity operator, is implemented as one of a generative neural network and a differentiable renderer, and/or is configured to output a synthetic eye image as prediction in response to receiving the input, and the training loss is determined based on the synthetic eye image and a corresponding visual feature representation extracted from the eye image, in particular a corresponding semantic segmentation of the eye image.

53. The method of claim 42, wherein at least one loss function is used to determine the training loss, wherein at least two differentiable predictors are used to determine a respective prediction for the at least one eye of the subject during the observation situation and/or for the observation time, wherein the training loss is determined based on each of the respective predictions, wherein the predicted 3D eye state is fed as input to a first differentiable predictor to determine a first prediction for the at least one eye of the subject during the observation situation and/or for the observation time as output of the first differentiable predictor, wherein the predicted 3D eye state is fed as input to a second differentiable predictor to determine the second prediction for the at least one eye of the subject during the observation situation and/or for the observation time as output of the second differentiable predictor, wherein the first prediction and the first eye-related observation or the second eye-related observation are fed as input to a first loss function to determine a first training loss as output of the first loss function; wherein the second prediction and the first eye-related observation, the second eye-related observation or a third eye-related observation are fed as input to a second loss function to determine a second training loss as output of the second loss function, wherein the second training loss is used to train the eye state predictor, and/or wherein the training loss is determined as a function of the first training loss and the second training loss.

54. The method of claim 42, wherein the training loss depends on at least one situation-specific parameter, wherein the training loss is used to amend and/or learn at least one situation-specific parameter, wherein both the eye state predictor and the differentiable predictor receive the at least one situation-specific parameter as part of the input, and/or wherein the at least one situation-specific parameter comprises at least one of: at least one subject-specific parameter and at least one hardware-specific parameter.

55. The method of claim 54, wherein the at least one subject-specific parameter is selected from a list consisting of an interpupillary distance, an angle between an optical and a visual axis of the respective eye, a rotation operator capturing a transformation between the optical axis and the visual axis, a geometric parameter referring to a shape and/or size of a cornea of the respective eye such as spherical, non-spherical, a thickness, an astigmatism, a 3D topography, and a radius, a refractive index of at least one component of the respective eye, an iris radius of the respective eye, a pupil shape, and a geometric parameter referring to a shape and/or size of an eyeball of the respective eye, wherein the subject specific parameter is determined in advance and/or as a respective physiological value, and/or wherein the at least one hardware-specific parameter is selected from a list consisting of: a respective camera intrinsics, relative camera extrinsics and a pose of the inertial measurement unit relative to at least one of the cameras.

56. The method of claim 53, further comprising at least one of:
using the predicted 3D eye state to determine a third training loss;
using, based on the predicted 3D eye state and the at least one situation-specific parameter, a third loss function to determine the third training loss;
using the third training loss to train the eye state predictor;
determining the training loss as a function of the first training loss and the third training loss; and
determining the training loss as a function of the first training loss, the second training loss and the third training loss.

57. A method for subject-specific parameter calibration, the method comprising:
providing a trained eye state predictor, the trained eye state predictor being trained according to claim 54; and performing the following steps:
feeding a respective first eye-related observation as input to the trained eye state predictor to determine a predicted 3D eye state of at least one eye of a new subject for an observation situation as output of the trained eye state predictor, the first eye-related observation referring to the at least one eye of the new subject in and/or during the observation situation;
feeding the predicted 3D eye state and a current value of the at least one subject-specific parameter for the new subject as input to a differentiable predictor to determine a prediction for the at least one eye of the new subject in and/or during the observation situation as output of the differentiable predictor;
determining, based on the prediction and at least one of the first eye-related observation and a respective second eye-related observation, a training loss, the respective second eye-related observation referring to the at least one eye of the new subject in and/or during the observation situation; and
using the training loss to update the current value of the at least one subject-specific parameter.

58. A method for predicting a 3D eye state for a subject in real time, the method comprising:
determining an eye-related observation referring to at least one eye of the subject; and
feeding the eye-related observation as input to a trained eye state predictor implemented as a neural network to determine a predicted 3D eye state as output of the trained eye state predictor, the predicted 3D eye state comprising a predicted 3D center of rotation of an eyeball of the at least one eye.

59. The method of claim 58, wherein the predicted 3D eye state comprises at least one of: a 3D gaze direction of the eyeball of the at least one eye and a predicted 3D state of a pupil of the at least one eye, the predicted 3D state of the pupil comprising at least one of: a predicted 3D pupil size of the at least one eye, a predicted 3D pupil aperture of an iris of the at least one eye, a predicted 3D pupil radius of an iris of the at least one eye, and a predicted 3D pupil diameter of the iris of the at least one eye, wherein the trained eye state predictor is trained according to the method of claim 42, wherein an eye camera of a head-wearable device worn by the subject is used for taking the at least one eye image, the head-wearable device being implemented as a spectacles device, and/or wherein the method is at least in part controlled and/or performed by a computing and control unit of the head-wearable device.

60. A system comprising:
a head-wearable device comprising at least one eye camera configured to generate eye images of at least a portion of an eye of the subject wearing the head-wearable device; and
a computing system connectable with the at least one eye camera for receiving the eye images, and configured to:
generate, based on an eye image referring to an observation situation and received from the at least one eye camera, a first eye-related observation referring to the eye of the subject in and/or during the observation situation;
run an eye state predictor implemented as a neural network;
feed the first eye-related observation as input to the eye state predictor to determine a predicted 3D eye state of the eye of the subject in and/or during the observation situation;
feed the predicted 3D eye state as input to a differentiable predictor to determine a prediction for the eye of the subject in and/or during the observation situation as output of the differentiable predictor;
determine, based on the prediction and at least one of the first eye-related observation and a second eye-related observation, a training loss, the second eye-related observation referring to the eye of the subject in and/or during the observation situation; and
use the training loss to train the eye state predictor.

61. A computer program product or a non-volatile computer-readable storage medium comprising instructions which, when executed by a one or more processors of a computing system, cause the computing system to carry out the method according to claim 42.
